(19) United States
(12) Patent Application Publication
(10) Pub. No.: US 2004/0012368 A1
(43) Pub. Date: Jan. 22, 2004

(54) Method and apparatus for charging a rechargeable cell

(76) Inventors: Paul G. Massey, Cupertino, CA (US); William D. Baumgartner, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/197,450

(22) Filed: Jul. 17, 2002

(51) Int. Cl. H02J 7/00

(52) U.S. Cl. 320/103

(57) ABSTRACT

A method and apparatus for charging a rechargeable cell or cells for portable electronic equipment (such as a rechargeable battery pack for a notebook computer) employing a DC-to-DC converter circuit to transfer energy from one or more source cells to one or more target cells. In one embodiment, a scavenging charger circuit is configurable to accommodate a variety of different types of rechargeable cells or battery packs depending upon factors such as the types, numbers and arrangements of rechargeable cells involved.

### BACKGROUND OF THE INVENTION

Many articles of portable electronic equipment use batteries or battery packs as a power source. Battery packs by virtue of their relatively small size and modular nature are particularly well suited for use with notebook computers and other portable computing devices. However, design tradeoffs necessitated by the cost and size limitations imposed upon battery designers and the technical limitations associated with the current state of the art have resulted in battery packs that typically need to be replaced and/or recharged far too frequently, thereby lessening the convenience of using such portable electronic devices.

For example, in a notebook computer that has only one battery slot, it is necessary to charge the battery in the notebook computer or by using an expensive, AC powered external charging unit. The less-than-optimal solution employed by many people is to carry two or more batteries with them at the expense of added weight in order to prolong the time that they will be able to use their portable electronic equipment away from an AC power source. In other instances, some time constraint may make it impossible to fully recharge a battery during a period of time when an AC source is available.

Smart Batteries, e.g., battery packs designed in compliance with the Smart Battery Charger Specification, control the charging algorithm of a Smart Battery Charger. Each Smart Battery controls the charging characteristics and defines a safe charging scheme that is suited to its chemistry and capacity, maximizing the usable energy at each charge, reducing the charge time and maximizing the number of charge cycles. A Smart Battery Charger is obligated to adjust its output characteristics in direct response to the Charging Voltage( ) and Charging Current( ) messages that it receives from the Smart Battery to provide a “controlled charge”. See, Smart Battery Charger Specification, Revision 1.1.

The Smart Battery Charger, however, is an example of an expensive, AC powered external charging unit. Moreover, such chargers sometimes operate too slowly to be effective when an AC power source is available for only a short period of time. Thus, there is a need for an inexpensive charging unit that is capable of quickly transferring energy to rechargeable cells.

### BRIEF DESCRIPTION OF THE DRAWINGS

Detailed description of embodiments of the invention will be made with reference to the accompanying drawings:

FIG. 1 illustrates a method of charging a rechargeable battery pack for portable electronic equipment employing a scavenging charger circuit according to the present invention;

FIG. 2 illustrates an exemplary embodiment of a manually switchable universal scavenging battery charger circuit according to the present invention; and

FIG. 3 illustrates an exemplary embodiment of an automatically switched universal scavenging battery charger circuit according to the present invention.

### DETAILED DESCRIPTION

The following is a detailed description of the best presently known mode of carrying out the invention. This description is not to be taken in a limiting sense, but is made merely for the purpose of illustrating the general principles of the invention.

The methods and apparatuses of the present invention are applicable to any rechargeable cell, plurality of cells or battery pack(s) for portable electronic equipment. The term “portable electronic equipment” includes, but is not limited to, portable computing devices (e.g., notebook and laptop computers), mobile telephones, and video cameras.

Embodiments of the present invention provides a fast and economical method and apparatus for charging a rechargeable cell without the portable electronic equipment (e.g., notebook computer) that uses the rechargeable cell or an AC adapter. As a result, the user does not have to carry as many extra batteries.

According to the present invention, a scavenging charger circuit is employed to transfer energy from one or more (partially charged) source cells to a target rechargeable cell such as a battery pack for portable electronic equipment. An exemplary charger unit is built from a DC-to-DC transformer and other relatively low-cost components. Consequently, charger units built according to the principles of the present invention are significantly less expensive than conventional “brick chargers” which include AC-to-DC rectifier and filtering circuitry.

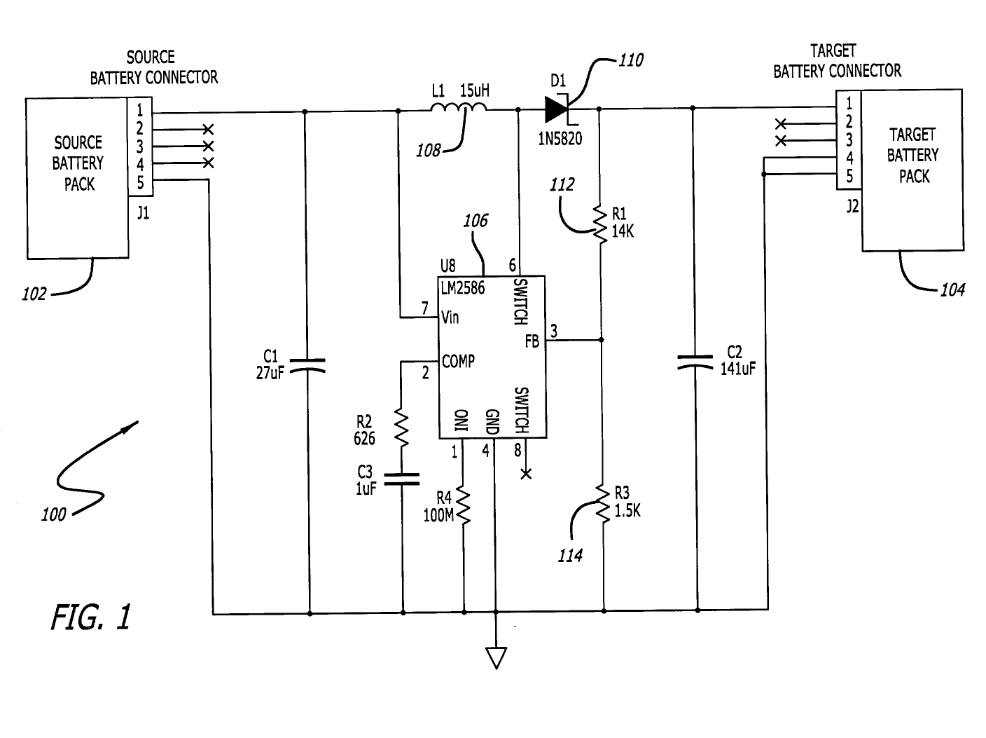

Referring to FIG. 1, a method of charging a rechargeable battery pack for portable electronic equipment according to the present invention involves using a charger unit such as the exemplary scavenging charger circuit 100. In the illustrated example, the charger circuit 100 is shown connected to a source battery pack 102 and a target battery pack 104. It should be reiterated, however, that the principles of the present invention are applicable to any rechargeable cell or configuration of rechargeable cells.

The exemplary scavenging charger circuit 100 comprises a regulator 106, an inductor 108, a diode 110, feedback resistors 112, 114 and other components configured as shown. The charger circuit 100 is designed to produce a regulated voltage suitable for charging the target cell or battery pack 104. In one embodiment, the charger circuit 100 acts as a constant-current charger.

The regulator 106 comprises, for example, a boost-buck converter biased as shown with appropriate components to output a constant voltage over the operating range of the source cell or battery pack 102. Boost-buck converters are devices that can produce a regulated output voltage from a source voltage that can be higher or lower than the desired output voltage. The regulator 106 comprises, for example, a regulator circuit, LM2586, available from National Semiconductor Corporation, which has been observed to produce a 16.8V output from as low as a 9V input. This output voltage is sufficient for charging four Li-Ion battery cells connected in series from source batteries consisting of three or four cells in series (common configurations for notebook computers). Other DC-to-DC converters can also be used.

The inductor 108 (L1) can be selected to provide a rate of charge (e.g., approximately 2.5C) and/or efficiency of charge transfer depending upon the characteristics desired for the charger circuit 100. In this example a completely discharged battery having a 10 amp-hour capacity charging at a rate of 1C would charge in 10 hours.

Returning now to the example of FIG. 1, the inductor 108 with an inductance of 15 μH can be used. Choosing an inductor sized for a lower current improves the efficiency of charge transfer but results in a slower charging. An exemplary diode 110 comprises a Schottky rectifier, 1N5820. The resistors 112, 114 (R1, R3) are chosen to provide the feedback necessary for producing a regulated voltage appropriate for the target cell or battery pack 104. For example, R1=14K Ω and R3=1.5K Ω. The capacitors, C1 and C2, are chosen empirically with the input capacitor C1 typically being in the range of 10 μF to 100 μF and the output capacitor C2 typically being in the range of 22 μF to 500 μF. The other component values, such as R2 (626 Ω), C3 (1 μF), and R4 (100 MΩ) are part-specific and typically specified by the vendor of regulator 106. Thus, the components can be selected to bias the boost-buck converter to operate over a desired voltage range at a desired energy transfer rate or efficiency.

In practice, and depending upon the design of the particular target battery pack, it may be necessary to ground (or otherwise “cheat”) sensors in the battery pack in order for the charger in the pack to turn on. By way of example, this is illustrated in FIG. 1 where pin 4 (which is connected to a thermistor inside the target battery pack 104) of the battery connector is shorted to ground.

Thus, a method of designing a scavenging charger circuit according to an embodiment of the present invention includes: selecting a regulator for a scavenging charger circuit depending upon voltage ranges of a source battery pack and of a rechargeable battery pack for portable electronic equipment; and selecting components for the scavenging charger circuit such that an approximate range of charge transfer efficiency from the source battery pack to the rechargeable battery pack is provided by the scavenging charger circuit. In another embodiment, the method further includes selecting the components depending upon numbers and/or types of cells within the source battery pack and the rechargeable battery pack.

A method of charging a rechargeable battery pack for portable electronic equipment according to an embodiment of the present invention includes: providing a charging circuit including a dc-to-dc converter, the charging circuit being configured for electrical interconnection with two battery packs, at least one of which is a rechargeable battery pack for portable electronic equipment; and connecting the battery packs to the charging circuit such that the charging circuit charges the rechargeable battery pack by scavenging charge from the other battery pack.

A method of charging a rechargeable battery pack for portable electronic equipment according to an embodiment of the present invention includes: providing a boost-buck converter circuit configured for electrical interconnection with two battery packs, at least one of which is a rechargeable battery pack for portable electronic equipment; and connecting the battery packs to the boost-buck converter circuit such that the boost-buck converter circuit charges the rechargeable battery pack by scavenging charge from the other battery pack.

A method of charging a rechargeable battery pack for a portable computer according to an embodiment of the present invention includes: providing a charging circuit including a dc-to-dc converter, the charging circuit being configured for electrical interconnection between at least two partially charged battery packs, at least one of which is a rechargeable battery pack for a portable computer; and connecting the partially charged battery packs to the charging circuit such that the charging circuit charges the rechargeable battery pack by scavenging charge from the other partially charged battery pack.

A method of charging a rechargeable battery pack for a portable computer according to an embodiment of the present invention includes: providing a boost-buck converter circuit configured for electrical interconnection with two battery packs, at least one of which is a rechargeable battery pack for a portable computer; and connecting the battery packs to the boost-buck converter circuit such that the boost-buck converter circuit charges the rechargeable battery pack by scavenging charge from the other battery pack.

There are a variety of different types (chemistry) and configurations of rechargeable cells for portable electronic equipment. For example, notebook computers often use battery packs made from 3 or 4 Li-ion cells in series. Some computers also use Nickel-Metal Hydride batteries, typically configured so as to have a pack voltage in the 14.6-16.8V range (to be consistent with 3- or 4-cell Li-Ion stacks). These configurations require different charging voltages, and possibly charging currents to maximize the capacity of the pack. As discussed below, additional embodiments of the present invention accommodate various possible combinations of rechargeable cells that are to be charged and source cells that are to have energy scavenged from them.

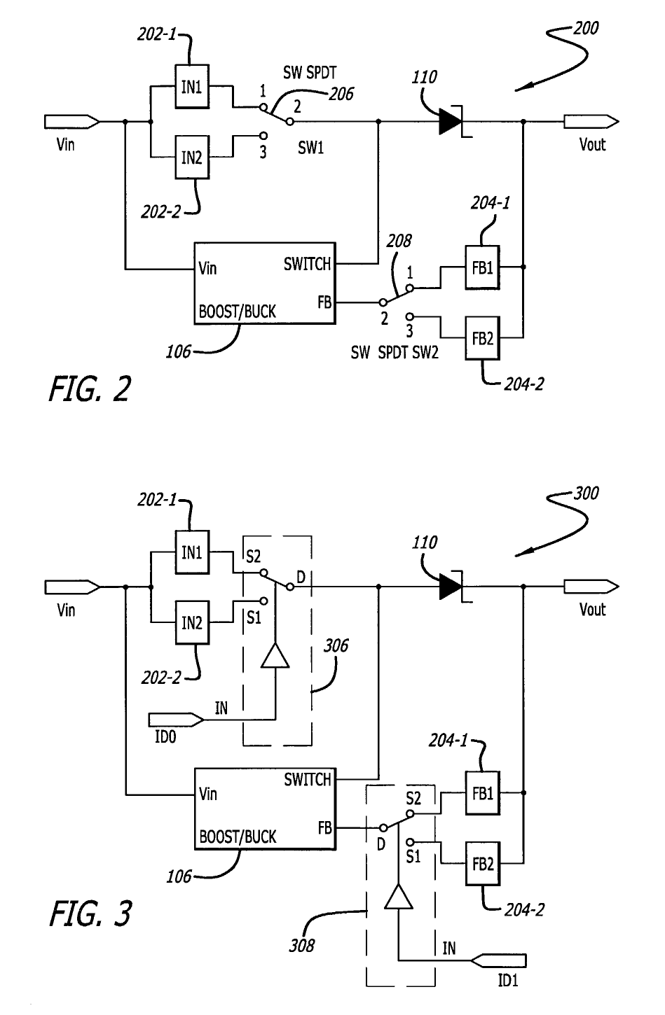

FIG. 2 illustrates an exemplary embodiment of a manually switchable universal scavenging battery charger circuit 200 according to the present invention. The charger circuit 200 is configured with switchable banks of components that are selected to accommodate various possible combinations of source and target cells, e.g., by type, number and/or configuration, etc. In the illustrated exemplary circuit, inductor components 202-1 (IN1) and 202-2 (IN2) and feedback resistor components 204-1 (FB1) and 204-2 (FB2) are configured as shown in switch-selectable arrangements. Functional blocks IN1 and IN2 correspond to two different inductor values to change the charge current. Functional blocks FB1 and FB2 correspond to two different feedback networks used to set the regulated output voltage. Manual switches 206 (SW1) and 208 (SW2) are used to make electrical connections to components in the IN1-IN2 and FB1-FB2 banks, respectively. Circuit details are left out of the figure for simplicity.

Operation of the circuit is as previously described, with the manual switches allowing the user to select the correct output voltage (SW2) and/or charge current (SW1). Although the illustrated exemplary charger circuit 200 includes both IN1-IN2 and FB1-FB2 banks, the circuit can include either or both banks of switch-selectable components. Moreover, the charger circuit is not limited to switching between only two different inductor values or feedback networks, rather it can be extended to utilize as many input and/or output combinations as desired (e.g., IN1-INX and/or FB1-FBY) using appropriate switches. Preferably, the most efficient regulator available is chosen given the ranges of possible input and output voltages to be accommodated by the charging circuit.

Thus, a circuit for charging one or more rechargeable cells for portable electronic equipment according to an embodiment of the present invention includes: a regulator and a plurality of components selected as a function of expected possible combinations of rechargeable cells that are to be charged and source cells that are to have energy scavenged from them by the circuit.

FIG. 3 illustrates an exemplary embodiment of an automatically switched universal scavenging battery charger circuit 300 according to the present invention. The illustrated exemplary charger circuit 300 differs from the charger circuit 200 (FIG. 2) in that the manual switches 206 and 208 are replaced with electronically controlled switches 306 and 308, respectively. By way of example, suitable parts for the switches 306 and 308 comprise ADG749 switches from Analog Devices.

In response to control inputs, the switches 306 and 308 select the correct components for the charger circuit 300 depending, for example, upon the type, number and/or configuration of the source and/or target cell(s). In one embodiment, data signals are provided to the switches 306 and 308 by one or more of the source cells and/or (rechargeable) target cell(s). In the illustrated charger circuit 300, ID pins (labeled ID0 and ID1) of a battery pack connector are used to switch the input and/or output functional blocks assuming, for example, that the designer has already made the charge time/charge capacity tradeoff and is simply accounting for the different charging parameters of two different types of battery packs (e.g., Li-Ion vs. NiMH).

As with the charger circuit of FIG. 2, the automatically switched charger circuit 300 is not limited to two inputs and/or outputs. By way of example, additional components and automatic switching circuitry can be added to provide greater flexibility such as the ability to make different component selection choices in the input functional blocks taking into consideration the tradeoff between the rate of discharge of a battery and the amount of useful life that it has. Thus, one possible use for the input functional blocks is to select a particular inductor to either maximize charge transfer or minimize charge time. Another possible use is to select an inductor based on the battery pack chemistry. Similarly, additional components and automatic switching circuitry can be added to provide the ability to make different component selection choices in the feedback networks to set the appropriate charging voltage for different rechargeable cells.

Thus, a circuit for charging one or more rechargeable cells for portable electronic equipment according to an embodiment of the present invention includes: a regulator and a plurality of components selected as a function of expected possible combinations of rechargeable cells that are to be charged and source cells that are to have energy scavenged from them by the circuit, wherein the circuit is configured to receive data signals and to automatically select a set of components from the plurality of components in the circuit depending upon the data signals. In another embodiment, the data signals are provided by one or more of the rechargeable cells and/or source cells.

A method of designing a scavenging charger circuit according to an embodiment of the present invention includes: selecting a regulator for a scavenging charger circuit depending upon voltage ranges of a source battery pack and of a rechargeable battery pack; selecting a plurality of different components for the scavenging charger circuit to provide a plurality of different possible output voltages and/or charge currents; and configuring the components to be switchably selectable depending upon numbers and/or types of cells within the source battery pack and/or the rechargeable battery pack. In another embodiment, the method further includes providing circuitry for automatically controlling switching of the components in response to data pertaining to the numbers and/or types of cells within the source battery pack and/or the rechargeable battery pack.

Although the present invention has been described in terms of the preferred embodiment above, numerous modifications and/or additions to the above-described preferred embodiment would be readily apparent to one skilled in the art. It is intended that the scope of the present invention extends to all such modifications and/or additions.

We claim:

1. A method of charging a rechargeable battery pack for portable electronic equipment, comprising:
providing a charging circuit including a dc-to-dc converter, the charging circuit being configured for electrical interconnection with two battery packs, at least one of which is a rechargeable battery pack for portable electronic equipment; and
connecting the battery packs to the charging circuit such that the charging circuit charges the rechargeable battery pack by scavenging charge from the other battery pack.

2. A method of charging a rechargeable battery pack for portable electronic equipment, comprising:
providing a boost-buck converter circuit configured for electrical interconnection with two battery packs, at least one of which is a rechargeable battery pack for portable electronic equipment; and
connecting the battery packs to the boost-buck converter circuit such that the boost-buck converter circuit charges the rechargeable battery pack by scavenging charge from the other battery pack.

3. A method of charging a rechargeable battery pack for a portable computer, comprising:
providing a charging circuit including a dc-to-dc converter, the charging circuit being configured for electrical interconnection between at least two partially charged battery packs, at least one of which is a rechargeable battery pack for a portable computer; and
connecting the partially charged battery packs to the charging circuit such that the charging circuit charges the rechargeable battery pack by scavenging charge from the other partially charged battery pack.

4. A method of charging a rechargeable battery pack for a portable computer, comprising:
providing a boost-buck converter circuit configured for electrical interconnection with two battery packs, at least one of which is a rechargeable battery pack for a portable computer; and
connecting the battery packs to the boost-buck converter circuit such that the boost-buck converter circuit charges the rechargeable battery pack by scavenging charge from the other battery pack.

5. A method of designing a scavenging charger circuit, comprising:
selecting a regulator for a scavenging charger circuit depending upon voltage ranges of a source battery pack and of a rechargeable battery pack for portable electronic equipment;
selecting components for the scavenging charger circuit such that an approximate range of charge transfer efficiency from the source battery pack to the rechargeable battery pack is provided by the scavenging charger circuit.

6. The method of designing a scavenging charger circuit of claim 5, wherein the step of selecting components further comprises:
selecting the components depending upon numbers of cells within the source battery pack and the rechargeable battery pack.

7. The method of designing a scavenging charger circuit of claim 5, wherein the step of selecting components further comprises:
selecting the components depending upon types of cells within the source battery pack and the rechargeable battery pack.

8. The method of designing a scavenging charger circuit of claim 5, wherein the step of selecting components further comprises:
selecting the components such that the scavenging charger circuit generates a desired charging voltage.

9. The method of designing a scavenging charger circuit of claim 5, wherein the step of selecting components further comprises:
selecting the components such that the scavenging charger circuit generates a desired charging current.

10. A circuit for charging one or more rechargeable cells for portable electronic equipment, comprising:
a regulator and a plurality of components selected as a function of expected possible combinations of rechargeable cells that are to be charged and source cells that are to have energy scavenged from them by the circuit.

11. The circuit for charging one or more rechargeable cells for portable electronic equipment of claim 10, wherein the rechargeable cells are for a portable computer.

12. The circuit for charging one or more rechargeable cells for portable electronic equipment of claim 10, wherein the regulator is a boost-buck converter

13. The circuit for charging one or more rechargeable cells for portable electronic equipment of claim 12, wherein the boost-buck converter is biased with appropriate components to output a constant voltage over an operating range of the source cells.

14. The circuit for charging one or more rechargeable cells for portable electronic equipment of claim 12, wherein the boost-buck converter is selected in consideration of a useful voltage range of the source cells.

15. The circuit for charging one or more rechargeable cells for portable electronic equipment of claim 12, wherein the boost-buck converter is configured to act as a constant current charger.

16. The circuit for charging one or more rechargeable cells for portable electronic equipment of claim 10, wherein the components are selected to maximize a rate of energy transfer.

17. The circuit for charging one or more rechargeable cells for portable electronic equipment of claim 10, wherein the components are selected to maximize a charge transfer efficiency.

18. The circuit for charging one or more rechargeable cells for portable electronic equipment of claim 10, wherein the components are selected in consideration of a trade off between charge time and charge transfer efficiency.

19. The circuit for charging one or more rechargeable cells for portable electronic equipment of claim 10, wherein the components are switchably selectable to provide a desired output voltage and/or charge current.

20. The circuit for charging one or more rechargeable cells for portable electronic equipment of claim 10, wherein the components include feedback resistors that are switch selectable to determine an output voltage of the circuit.

21. The circuit for charging one or more rechargeable cells for portable electronic equipment of claim 10, wherein the components include inductors that are switch selectable to determine a rate of charge provided by the circuit.

22. The circuit for charging one or more rechargeable cells for portable electronic equipment of claim 10, wherein the circuit is configured to receive data signals and to automatically select a set of components from the plurality of components in the circuit depending upon the data signals.

23. The circuit for charging one or more rechargeable cells for portable electronic equipment of claim 22, wherein the data signals are provided by one or more of the rechargeable cells and/or the source cells.
